(19) United States
(12) Patent Application Publication
(10) Pub. No.: US 2010/0007862 A1
(43) Pub. Date: Jan. 14, 2010

(54) EXPOSURE APPARATUS AND DEVICE MANUFACTURING METHOD

(75) Inventor: Tsuyoshi Arai, Utsunomiya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/498,827

(22) Filed: Jul. 7, 2009

(30) Foreign Application Priority Data
Jul. 10, 2008 (JP) 2008-180682

(51) Int. Cl. G03B 27/52; G03B 27/62; G03B 27/32

(52) U.S. Cl. 355/30; 355/75; 355/77

(57) ABSTRACT

An apparatus that projects a pattern of an original, onto a substrate held by a substrate stage having a top plate, to expose the substrate, comprises a cleaning unit, the cleaning unit including a discharge nozzle configured to discharge a fluid toward the top plate, and a recovery nozzle configured to recover the fluid discharged from the discharge nozzle, wherein an opening of the recovery nozzle has a shape which surrounds a path of the fluid discharged from the discharge nozzle.

### BACKGROUND OF THE INVENTION

1. Field of the Invention

The present invention relates to an exposure apparatus and a device manufacturing method using the same.

2. Description of the Related Art

In the process of manufacturing a semiconductor device, an exposure apparatus which reduces a pattern formed on an original and projects and transfers the pattern onto a substrate is employed. As traditional approaches to improve the resolving power of the exposure apparatus in order to allow the transfer of a fine pattern, there are approaches of shortening the wavelength of the exposure light, and of increasing the numerical aperture (NA) of the projection optical system. As for the former approach, the current mainstream exposure light is an ArF excimer laser beam having a wavelength of 193 nm.

An immersion method is attracting a great deal of attention as an approach that is quite different from those described above. In the immersion method, the space between the projection optical system and the substrate is filled with a liquid, and the original pattern is projected onto the substrate via the projection optical system and the liquid.

If a particle is present on the top plate of the substrate stage in the exposure apparatus, it may shield the exposure beam upon moving into the exposure space, or may cause an exposure failure upon adhering onto the substrate or the projection optical system. Also, if a particle adheres onto the measurement marks arranged on the top plate of the substrate stage, it may cause a failure in mark measurement. Such results are likely to occur especially in an immersion exposure apparatus in which the immersion liquid relatively moves on the top plate of the substrate stage or the measurement marks on the top plate in order for exposure and mark measurement.

In the immersion exposure apparatus, the top plate of the substrate stage often has undergone a water-repellent treatment so as to facilitate recovery of the immersion liquid. If a portion, on the top plate, which is in contact with the immersion liquid is contaminated, this may deteriorate the water repellency of the top plate and therefore make the liquid recovery insufficient. As a consequence, the liquid may stay behind on the top plate of the substrate stage or spill out of the substrate stage.

Japanese Patent Laid-Open No. 2006-179909 describes a lithography apparatus including a cleaning device configured to clean at least one of the surfaces of the final optical element, the substrate table, and constituent components or structures exposed to the gas. Unfortunately, Japanese Patent Laid-Open No. 2006-179909 does not show detailed cleaning configurations except for that to exchange the immersion liquid for a cleaning fluid. An especially serious shortcoming in Japanese Patent Laid-Open No. 2006-179909 is that it discloses none of the detailed configurations of a cleaning unit separated from the projection optical system, for example, the definition of a region to be cleaned and the configuration to supply and recover a cleaning fluid.

To clean the top plate of the substrate stage, a cleaning unit arranged separately from the projection optical system is considered effective. This is because, in a scheme of arranging a cleaning unit in the lower portion of the projection optical system and performing cleaning by the cleaning unit, the region to be cleaned needs to be moved to the lower portion of the projection optical system. This means that, for example, cleaning cannot be performed parallel to an exposure operation. Another drawback of this scheme is that the final surface of the projection optical system is exposed to the cleaning fluid during the cleaning of the substrate stage.

### SUMMARY OF THE INVENTION

One of the aspects of the present invention provides an exposure apparatus that projects a pattern of an original, via a projection optical system, onto a substrate held by a substrate stage having a top plate, to expose the substrate, the apparatus comprising a cleaning unit separated from the projection optical system, the cleaning unit including a discharge nozzle configured to discharge a fluid toward the top plate, and a recovery nozzle configured to recover the fluid discharged from the discharge nozzle toward the top plate, wherein an opening of the recovery nozzle has a shape which surrounds a path of the fluid discharged from the discharge nozzle.

Further features of the present invention will become apparent from the following description of exemplary embodiments with reference to the attached drawings.

### BRIEF DESCRIPTION OF THE DRAWINGS

FIG. 1 is a view showing the schematic arrangement of an exposure apparatus according to an embodiment of the present invention;

FIG. 2 is a view for explaining an issue posed by a particle;

FIG. 3 is a view for explaining another issue posed by a particle;

FIG. 4 is a view showing an example of the configuration of a cleaning unit according to the embodiment of the present invention;

FIG. 5 is a view showing another example of the configuration of a cleaning unit according to the embodiment of the present invention;

FIG. 6 is a view showing an example of the partial configuration of a cleaning unit according to the embodiment of the present invention; and

FIG. 7 is a flowchart for explaining an exemplary procedure for a process of cleaning a top plate by a cleaning unit.

### DESCRIPTION OF THE EMBODIMENTS

An embodiment of the present invention will be described below with reference to the accompanying drawings, but the present invention is not limited to this.

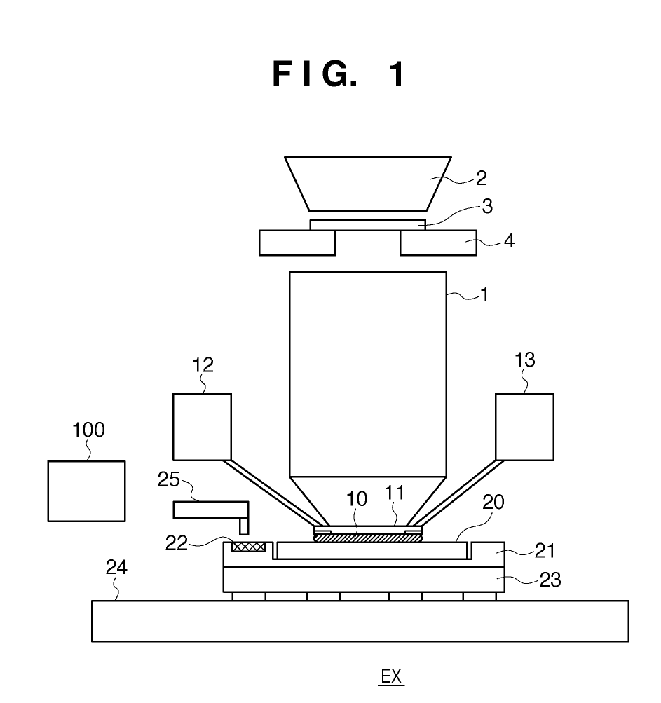

FIG. 1 is a view showing the schematic arrangement of an exposure apparatus according to an embodiment of the present invention. An exposure apparatus EX shown in FIG. 1 is configured as an immersion exposure apparatus which projects the pattern of an original (also called a reticle or mask) 3 onto a substrate (e.g., a wafer) 20 via a projection optical system 1 and an immersion liquid 10 to expose the substrate 20. However, the present invention is applicable to all kinds of exposure apparatuses, including substrate stages to be cleaned, such as an exposure apparatus which exposes the substrate while the space between the projection optical system and the substrate is filled with a gas.

The exposure apparatus EX includes, for example, an illumination optical system 2, an original stage 4, the projection optical system 1, a substrate stage 23, a stage base plate 24, an immersion liquid supply unit 12, an immersion liquid recovery unit 13, a measurement device 25, and a cleaning unit 100.

When the exposure apparatus EX is configured as a scanning exposure apparatus, the illumination optical system 2 illuminates a part of the original 3 held by the original stage 4 with light provided by a light source (not shown). The original stage 4 and the substrate stage 23 are driven by synchronously scanning them while the original 3 is illuminated. By this scanning driving, the entire pattern of the original 3 is continuously projected onto the substrate 20 via the projection optical system 1 to form a latent pattern on a photoresist (resist) applied on the surface of the substrate 20.

A nozzle unit 11 is disposed around the final surface of the projection optical system 1 to face the substrate 20 (or a top plate 21 of the substrate stage 23). An immersion liquid (a liquid for immersion) 10 is supplied from the immersion liquid supply unit 12 to the nozzle unit 11, and recovered from the nozzle unit 11 by the immersion liquid recovery unit 13, thereby maintaining a film of the immersion liquid 10 in the space between the substrate 20 and the final surface of the projection optical system 1.

The substrate stage 23 includes the top plate 21 on its upper portion. The substrate 20 is held by a chuck (not shown) built in the top plate 21. The top plate 21 mounts a mark unit 22 including marks formed for alignment and calibration measurements by the measurement device 25.

When the substrate stage 23 moves on the stage base plate 24 in order for an exposure operation or to measure the marks formed in the mark unit 22, the immersion liquid 10 can relatively move to the region outside the substrate 20. Under the circumstances, the upper surfaces of the top plate 21 and mark unit 22 are set nearly flush with the substrate 20 held in position.

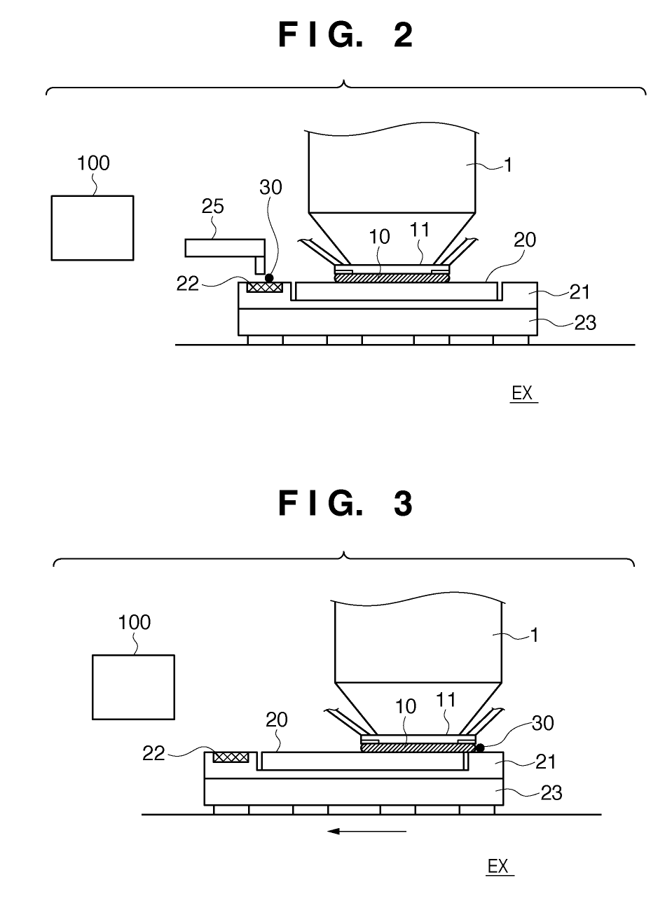

In this exposure apparatus, if a particle 30 is adhering on the mark unit 22 mounted on the top plate 21, as shown in FIG. 2, the measurement device 25 may suffer a measurement failure.

Also, if a particle 30 is present on the upper surface of the top plate 21, it is naturally trapped in the immersion liquid 10 as the substrate stage 23 moves. The trapped particle 30 may enter the exposure space (the space through which the exposure beam passes) in the immersion liquid 10, and then it may shield the exposure beam or adhere onto the surface of the substrate 20 or projection optical system 1, resulting in an exposure failure.

The upper surface of the top plate 21 has typically undergone a liquid-repellent treatment so as to facilitate recovery of the immersion liquid 10. If a portion, on the upper surface of the top plate 21, which is in contact with the immersion liquid 10 is contaminated, this may deteriorate the liquid repellency of the upper surface of the top plate 21 and therefore make the recovery of the immersion liquid 10 insufficient. As a consequence, the immersion liquid 10 may stay behind on the top plate 21 or spill out onto the stage base plate 24.

Conceivable examples of the particle which adversely affects the operations of an exposure apparatus are a particle adhering on a substrate loaded into the exposure apparatus, flakes of the resist and its top coat, and a particle floating in the air-conditioned space. Other conceivable examples of the foregoing particle are a particle which adheres onto an exposure apparatus during its installation and assembly, and a particle which adheres onto the exposure apparatus during its long-term stop. Conceivable examples of impurities which contaminate the top plate 21 are organic and inorganic substances contained in the gas in the air-conditioned space, photoproducts which are generated by the resist and its top coat and dissolved in the immersion liquid, and organic and inorganic substances contained in the immersion liquid itself.

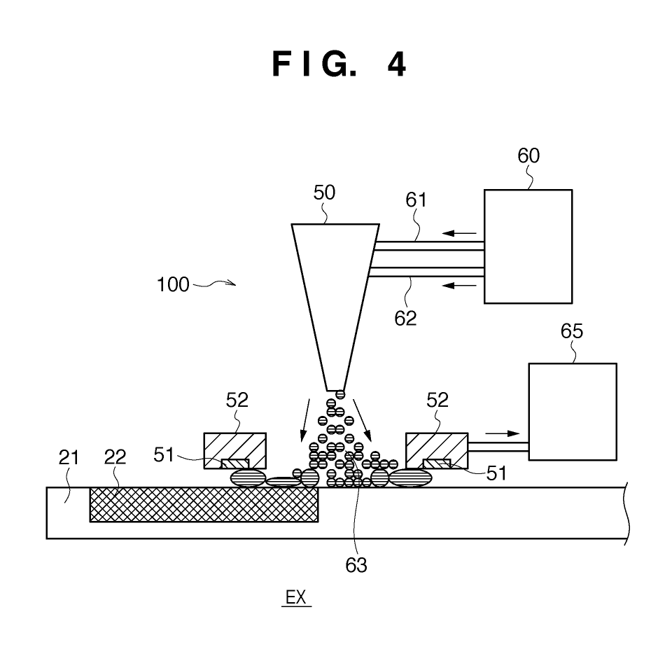

FIG. 4 is a view schematically showing an example of the configuration of the cleaning unit 100. The cleaning unit 100 is separated from the projection optical system 1. A configuration in which the cleaning unit 100 is separated from the projection optical system 1 allows cleaning a portion to be cleaned (e.g., the top plate 21 or the mark unit 22 mounted on it) parallel to an exposure operation. This configuration also allows cleaning a portion to be cleaned without exposing the projection optical system 1 to the cleaning fluid. This can bring, for example, the projection optical system 1 is prevented from being corroded due to the presence of the cleaning fluid, and there is no need for a process of rinsing the projection optical system 1 after the cleaning. The cleaning unit 100 may be arranged so as to be fixed in position or moved by a driving mechanism.

The cleaning unit 100 includes a discharge nozzle 50 which discharges a fluid 63 onto the top plate 21 of the substrate stage 23 (or onto the mark unit 22), and a recovery nozzle 52 which recovers the fluid 63 discharged from the discharge nozzle 50 onto the top plate 21. An opening 51 of the recovery nozzle 52 has a shape which surrounds the path of the fluid 63 discharged from the discharge nozzle 50. The opening 51 of the recovery nozzle 52 is located to face the top plate 21. When the fluid 63 contains both a liquid and a gas, the recovery nozzle 52 is configured to recover at least the liquid. The opening 51 of the recovery nozzle 52 has a shape (e.g., a circular, elliptical, or another ring shape or a rectangular shape) which surrounds the entire circumference of the path of the fluid 63 discharged from the discharge nozzle 50.

An example of the discharge nozzle 50 is a two-fluid nozzle which discharges a mixture of a gas and a liquid. Note that nitrogen and pure water, for example, can be used as the gas and the liquid, respectively. A gas and a liquid are supplied from a fluid supply unit 60 to the discharge nozzle 50 through a gas supply pipe 61 and a liquid supply pipe 62, respectively. At this time, a pressurized gas is supplied to the discharge nozzle 50. A high-speed flow of the pressurized gas atomizes the liquid inside the discharge nozzle 50. When this occurs, minute droplets having a particle diameter within the range of, for example, about 0.1 μm to 100 μm are discharged at high speed from the tip of the discharge nozzle 50. The fluid 63 containing these droplets impinges on the top plate 21 and the mark unit 22 mounted on it, producing a shock wave and a jet stream. These physical forces wash away the particles and impurities present on the upper surfaces of the top plate 21 and the mark unit 22 mounted on it.

The discharge nozzle 50 can be provided with a notch at its tip (opening) so as to discharge the fluid 63 in, for example, a fan-like or sheet-like form. This makes it possible to widen the area that can be cleaned at once. The discharge nozzle 50 may be configured so as to discharge the fluid 63 in a direction perpendicular to the upper surface of the top plate 21 or in a direction tilted with respect to that upper surface.

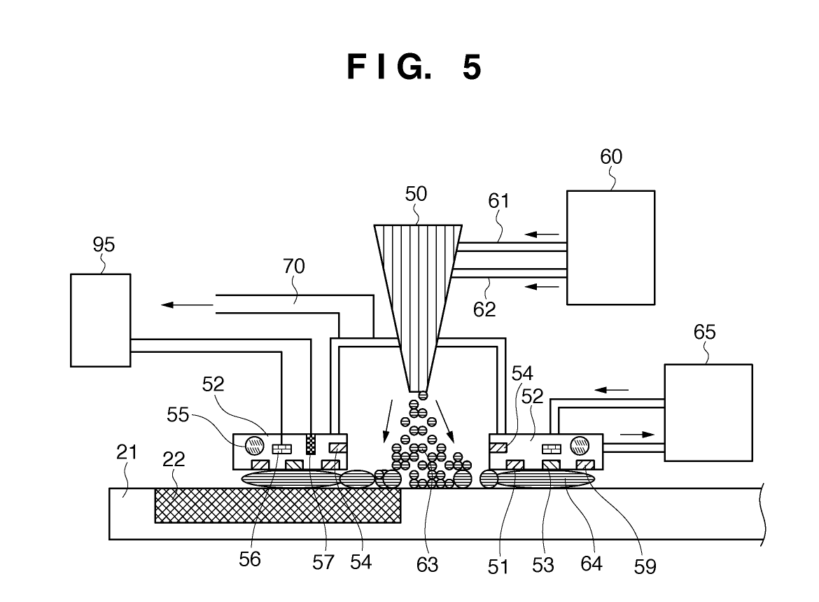

FIG. 5 is a view schematically showing an example of the configuration of the cleaning unit 100. The cleaning unit 100 further includes a cover 80 which prevents the fluid 63 discharged from the discharge nozzle 50 from scattering. Note that the fluid 63 discharged from the discharge nozzle 50 can also contain a liquid floating as mist. The cover 80 can include a facing portion 82 having a facing surface 81 which faces the top plate 21. The facing surface 81 surrounds the entire circumference of the path of the fluid 63 discharged from the discharge nozzle 50, and faces the top plate 21 with a gap between them. The opening 51 of the recovery nozzle 52 can be formed in the facing surface 81.

As a misty fluid 63, that is, a large number of droplets discharged from the discharge nozzle 50 impinge on the top plate 21, they combine with each other and are recovered from the opening 51. However, depending on the ratio between a gas and liquid supplied to the discharge nozzle 50, the amount of liquid discharged from the discharge nozzle 50 is often too small to clean the portion to be cleaned. In this case, the liquid discharged from the discharge nozzle 50 passes through the gap between the top plate 21 and the opening 51 of the recovery nozzle 52 at high speed while remaining as minute droplets.

To avoid this situation, the cleaning unit 100 includes a supply port 53 which supplies a liquid to a region, which lies in the gap between the top plate 21 and the facing surface 81 of the cover 80 and falls outside the opening 51 of the recovery nozzle 52, so as to form a liquid film 64 in that region. The liquid film 64 formed serves to prevent the droplets from passing through the gap between the top plate 21 and the opening 51 of the recovery nozzle 52. The supply port 53 can be formed, for example, in the facing surface 81 outside the opening 51 of the recovery nozzle 52. The cleaning unit 100 also includes a recovery port 59 which recovers the liquid which forms a liquid film 64 (and the fluid 63 which has not been recovered through the recovery nozzle 52). The recovery port 59 can be formed, for example, in the facing surface 81 outside the supply port 53.

The liquid supplied to the gap between the facing surface 81 and the top plate 21 through the supply port 53 is identical to that contained in the cleaning fluid 63. The liquid film 64 can be maintained in the gap by continuing to supply a liquid to the gap from the supply port 53, and recovering the liquid through the opening 51 and recovery port 59 of the recovery nozzle 52. The fluid 63 as minute droplets discharged from the discharge nozzle 50 is trapped and recovered by the liquid film 64 upon impinging on it. The opening 51 and recovery port 59 of the recovery nozzle 52 are connected to a liquid supply/recovery unit 65, and the liquid is sucked by the liquid supply/recovery unit 65 through the opening 51 and recovery port 59 of the recovery nozzle 52. The liquid supply/recovery unit 65 supplies a liquid to the supply port 53.

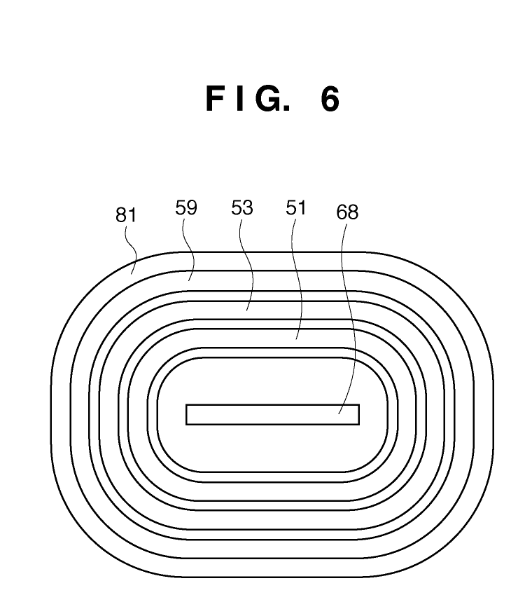

FIG. 6 is a view illustrating the structure of the facing surface 81 of the cleaning unit 100. FIG. 6 schematically shows a range 68 in which the fluid discharged from the discharge nozzle 50 impinges on the portion to be cleaned. The opening 51, recovery port 59, and supply port 53 of the recovery nozzle 52 have a shape (e.g., a circular, elliptical, or another ring shape or a rectangular shape) which, for example, surrounds the entire circumference of the range 68 in which the fluid 63 impinges on the portion to be cleaned.

To uniform the amount of fluid which passes through the opening 51, recovery port 59, and supply port 53 of the recovery nozzle 52 irrespective of the position, the opening 51, the recovery port 59, and the supply port 53 accommodate porous members or porous plates.

The cleaning unit 100 is arranged so as to form a predetermined gap between the facing surface 81 and the top plate 21. To satisfactorily form a liquid film 64 in the gap between the top plate 21 and the recovery nozzle 52, this gap has a width of approximately 2 mm or less.

The recovery port 59 may be imparted with the function of the recovery nozzle 52 (the opening 51) upon removing the recovery nozzle 52 (the opening 51). Depending on, for example, the amount of fluid discharged from the discharge nozzle 50, and the size of droplets formed, the supply port 53 may often be unnecessary.

In a space 83 inside the cover 80 which prevents the fluid 63 from scattering, droplets floating as mist may exist. The space 83 is fed with a gas used to discharge a liquid. To control this operation, the cleaning unit 100 includes a suction unit 90 which sucks the droplets and gas from the space 83 through an exhaust path 70.

In order to prevent deterioration in the shape of a liquid film 64 formed in the gap between the top plate 21 and the facing surface 81, the pressure inside the space 83 is kept constant. To attain this operation, the suction unit 90 operates as a pressure regulator which keeps the pressure inside the space 83 constant. A pressure regulator can also be implemented in a simpler configuration by providing the cover 80 with a through hole through which the internal and external spaces of the cover 80 communicate with each other.

The cleaning unit 100 further includes an exhaust port 54 which exhausts the liquid from inside the cover 80 to inhibit the level of the liquid collecting inside the cover 80 from rising in excess of a prescribed level. The exhaust port 54 can be formed, for example, inside the facing portion 82. The exhaust port 54 is also useful in preventing the liquid from being sucked by the suction unit 90.

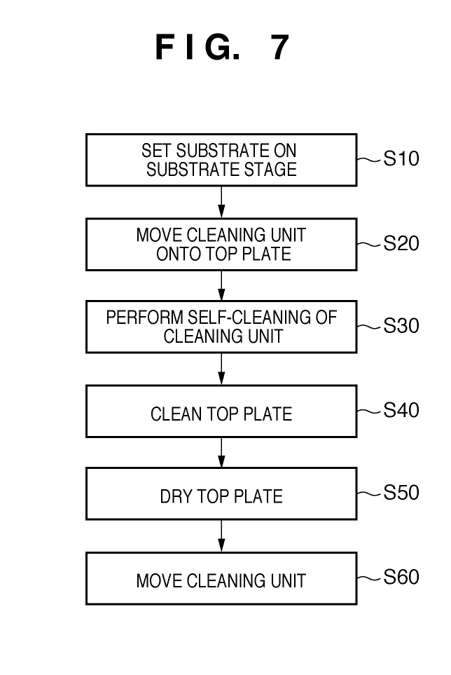

FIG. 7 is a flowchart for explaining an exemplary procedure for a process of cleaning the top plate 21 by the cleaning unit 100. Note that the top plate 21 to be cleaned by the cleaning unit 100 may include a mark unit 22.

In step S10, a substrate operation mechanism sets a cleaning process substrate on a chuck mounted on the top plate 21 of the substrate stage 23. The cleaning process substrate can have a liquid-repellent surface. Examples of such a cleaning process substrate are a substrate which is coated with HMDS (hexamethyldisilane) and a top coat, and that coated with a fluorocarbon resin. Cleaning process substrates are stocked in a maintenance wafer cassette. The surface of the cleaning process substrate can be periodically cleaned by the cleaning unit 100. At this time, not only the cleaning process substrate but also the surface of the top plate 21 may be cleaned.

In step S20, a transport mechanism transports the cleaning unit 100 onto the top plate 21. The transport mechanism may be, for example, that dedicated to this operation or a robot used for the maintenance of, for example, the chuck mounted on the top plate 21.

In step S30, the cleaning unit 100 performs self-cleaning. The self-cleaning can be performed by, for example, discharging a fluid from the discharge nozzle 50 and recovering the fluid by the recovery nozzle 52 while the cleaning unit 100 and the substrate stage 23 stand still. This self-cleaning makes it possible to prevent the entire surface (or the portion to be cleaned) of the top plate 21 from being contaminated if the cleaning unit 100 is contaminated.

In step S40, the top plate 21 (the substrate stage 23) can be driven relative to the cleaning unit 100, so that the portion to be cleaned (e.g., the whole) of the top plate 21 is cleaned, while a fluid is discharged from the discharge nozzle 50 and recovered by the recovery nozzle 52. Instead of driving the substrate stage 23, the cleaning unit 100 may be moved by the above-mentioned transport mechanism. Alternatively, both the substrate stage 23 and the cleaning unit 100 may be driven. During this cleaning, the boundary region between the cleaning process substrate and the top plate 21 can also be cleaned.

It is possible to regulate the cleaning power of the cleaning unit 100 and damage to the top plate 21 upon cleaning by regulating, by the fluid supply unit 60, the pressures of a liquid and gas supplied to the discharge nozzle 50 and their mixture ratio. The cleaning power of the cleaning unit 100 may also be regulated by controlling the moving speed of the substrate stage 23. For example, to clean a mark unit 22 which is vulnerable to damage upon cleaning, it is effective to drop the pressures of a liquid and gas supplied to the discharge nozzle 50. In this case, degradation in the cleaning power may be compensated by slowing down the moving speed of the substrate stage 23 to prolong the cleaning time.

In step S50, when the liquid remains in, for example, the groove in the top plate 21, a gas is blown to the position where the liquid remains, thereby removing the liquid. In other words, the top plate 21 is dried in step S50. At the same time, the channel of the discharge nozzle 50 is dried by supplying a gas to the liquid supply pipe 62 as well. Examples of the drying gas are dry air or dry nitrogen.

In step S60, the transport mechanism transports the cleaning unit 100 from above the top plate 21 to a standby position. Prior to this transportation, the lower portion of the cleaning unit 100 may be capped with a lid to prevent the liquid from dripping off the cleaning unit 100 onto the top plate 21 and the stage base plate 24. The cleaning unit 100 can be stored in a clean space in order to prevent its contamination. The cleaning unit 100 can be kept clean by being stored in, for example, a hydrogen peroxide solution.

The fluid supply unit 60 and the liquid supply/recovery unit 65 each can include, for example, a pressure feed pump, control valve, pressure sensor, flow sensor, filter, and tank. The liquid recovered by the liquid supply/recovery unit 65 can be exhausted outside the exposure apparatus after being separated into a gas and a liquid. The gas sucked by the suction unit 90 can be exhausted outside as well after removing the droplets from it by, for example, a filter.

When the recovery nozzle 52 recovers the liquid or is dried, the temperature of the recovery nozzle 52 often drops due to the influence of evaporative cooling of the liquid. A drop in the temperature of the recovery nozzle 52 adversely affects components of the exposure apparatus, which are present near the recovery nozzle 52. To combat this issue, a temperature regulation mechanism is provided to the fluid supply unit 60 or the liquid supply/recovery unit 65 and supply a temperature-regulated fluid or liquid to the discharge nozzle 50 or the supply port 53. Alternatively, a temperature regulation channel 55 may be separately provided to the recovery nozzle (nozzle unit) 52 as a temperature regulator, and supplied with a temperature-regulated liquid. Branched channels and control valves may be set in the channel 55, and a fluid or a liquid from the fluid supply unit 60 or the liquid supply/recovery unit 65 may be used as a temperature-regulated fluid or liquid for the foregoing purpose. Moreover, a heater 56 and a temperature sensor 57 may be disposed inside or on the surface of the recovery nozzle (nozzle unit) 52 as a temperature regulator. The recovery nozzle 52 is heated by the heater 56 by detecting the temperature of the recovery nozzle 52 by the temperature sensor 57, and controlling the temperature of the heater 56 by a temperature controller 95 based on the obtained detection result. Although FIG. 5 shows both the channel 55 and the heater 56, one of them need only be provided to the recovery nozzle 52.

Although a mechanism which drives the substrate stage 23 is not shown in the accompanying drawings, it can include, for example, a linear motor, laser interferometer, target mirror, control circuit, and driver.

In addition to pure water, a useful cleaning liquid includes, for example, chemical solutions such as solvents and surfactants, electrolytes such as ionized alkaline water, and functional water obtained by adding, for example, ammonia, hydrogen peroxide, ozone, hydrogen, or carbon dioxide to pure water. It is especially very effective to dissolve carbon dioxide in pure water in order to prevent the portion to be cleaned from being electrified upon discharging the pure water. If the portion to be cleaned is cleaned by a chemical solution, the discharge nozzle 50, the supply port 53, and the portion to be cleaned may be rinsed by exchanging the liquid supplied from the discharge nozzle 50 and the supply port 53 for pure water after the cleaning. The rinsing after the cleaning may be performed using the nozzle unit 11 for supplying/recovering an immersion liquid.

Although the supply port 53 is formed outside the opening 51 of the recovery nozzle 52 in the configuration example shown in FIGS. 5 and 6, an outlet for blowing pressurized air may be formed outside the opening 51 in order to keep the fluid 63 containing minute droplets collecting inside the opening 51.

The discharge nozzle 50 is not limited to a two-fluid nozzle, and may be a nozzle which discharges a liquid alone. Also, the discharge nozzle 50 may be configured as, for example, an ultrasonic nozzle which discharges a liquid applied with ultrasound. An ultrasonic nozzle which applies ultrasound to a liquid can include, for example, an ultrasonic transducer and diaphragm. The discharge nozzle 50 may be configured to discharge a gas alone. The top plate 21 can be cleaned by exhausting any particles flung up upon discharging a gas. The discharge nozzle 50 may also be configured to blow an ionized gas.

When a cleaning liquid containing a surfactant is used and a two-fluid nozzle or an ultrasonic nozzle is used as the discharge nozzle 50, the cleaning liquid may be supplied from the supply port 53, and pure water or functional water may be discharged from the discharge nozzle 50. This makes it possible to suppress the generation of foams of the cleaning liquid, thus quickly recovering the cleaning solvent.

The present invention is also applicable to an exposure apparatus including a plurality of substrate stages. In this case, the top plates of the plurality of substrate stages may be cleaned in turn or cleaned at once by setting a plurality of cleaning units at appropriate positions. Needless to say, the stage to be cleaned is not limited to that which mounts a substrate, and may be that which mounts, for example, measurement marks alone. In an immersion exposure apparatus, all surfaces which come into contact with an immersion liquid are cleaned.

Periodically cleaning the top plate of the substrate stage using the cleaning unit makes it possible to prevent any exposure failure due to the presence of particles, the carriage of any particles to the then subsequent step, and any measurement failure of the measurement marks. This, in turn, makes it possible to improve the yield of a device to be manufactured.

A device manufacturing method according to an embodiment of the present invention is suitable for manufacturing, for example, a semiconductor device and a liquid crystal device. This method may include, for example, a step of transferring the pattern of an original onto a photoresist applied on a substrate using the above-mentioned exposure apparatus, and a step of developing the photoresist. The devices are manufactured by further other known steps (e.g., etching, resist removal, dicing, bonding, and packaging).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-180682, filed Jul. 10, 2008, which is hereby incorporated by reference herein in its entirety.

What is claimed is:

1. An exposure apparatus that projects a pattern of an original, via a projection optical system, onto a substrate held by a substrate stage having a top plate, to expose the substrate, the apparatus comprising:
a cleaning unit separated from the projection optical system, the cleaning unit including
a discharge nozzle configured to discharge a fluid toward the top plate, and
a recovery nozzle configured to recover the fluid discharged from the discharge nozzle toward the top plate,
wherein an opening of the recovery nozzle has a shape which surrounds a path of the fluid discharged from the discharge nozzle.

2. The apparatus according to claim 1, wherein the opening is facing the top plate.

3. The apparatus according to claim 1, wherein the opening has a shape which surrounds a circumference of the path of the fluid discharged from the discharge nozzle.

4. The apparatus according to claim 1, wherein
the cleaning unit further includes a cover configured to prevent the fluid discharged from the discharge nozzle from scattering,
the cover surrounds a circumference of the path of the fluid discharged from the discharge nozzle and has a facing surface which faces the top plate with a gap therebetween, and
the opening is formed in the facing surface.

5. The apparatus according to claim 4, wherein the cleaning unit further includes a supply port configured to supply a liquid to a region, which lies in the gap between the top plate and the facing surface and falls outside the opening, so as to form a liquid film in the region.

6. The apparatus according to claim 5, wherein
the supply port is formed in the facing surface outside the opening, and
the cleaning unit further includes a recovery port, which is formed in the facing surface outside the supply port.

7. The apparatus according to claim 4, wherein
the fluid discharged from the discharge nozzle contains a liquid, and
the cleaning unit further includes an exhaust port configured to exhaust the liquid from inside the cover to inhibit a level of the liquid collecting inside the cover from rising in excess of a prescribed level.

8. The apparatus according to claim 4, wherein the cleaning unit further includes a pressure regulator configured to regulate a pressure of a space inside the cover.

9. The apparatus according to claim 1, wherein the discharge nozzle includes a two-fluid nozzle configured to discharge a liquid and a gas.

10. The apparatus according to claim 1, wherein the apparatus is configured as an immersion exposure apparatus which projects the pattern via a liquid and the projection optical system.

11. The apparatus according to claim 1, wherein the cleaning unit includes a temperature regulator configured to regulate a temperature of the recovery nozzle.

12. The apparatus according to claim 11, wherein the temperature regulator includes a channel which is set in the recovery nozzle and through which a temperature-regulated liquid flows.

13. The apparatus according to claim 11, wherein the temperature regulator includes a sensor configured to detect the temperature of the recover nozzle, and a heater configured to heat the recovery nozzle based on the detection result obtained by the sensor.

14. A device manufacturing method comprising:
exposing a substrate coated with a photoresist using an exposure apparatus that projects a pattern of an original, via a projection optical system, onto the substrate held by a substrate stage having a top plate, to expose the photoresist on the substrate; and
developing the photoresist,
wherein the exposure apparatus comprises a cleaning unit separated from the projection optical system,
the cleaning unit including
a discharge nozzle configured to discharge a fluid toward the top plate, and
a recovery nozzle configured to recover the fluid discharged from the discharge nozzle toward the top plate,
wherein an opening of the recovery nozzle has a shape which surrounds a path of the fluid discharged from the discharge nozzle.

15. An apparatus that projects a pattern of an original, onto a substrate held by a substrate stage having a top plate, to expose the substrate, the apparatus comprising:
a cleaning unit including
a discharge nozzle configured to discharge a fluid toward the top plate, and
a recovery nozzle configured to recover the fluid discharged from the discharge nozzle,
wherein an opening of the recovery nozzle has a shape which surrounds a path of the fluid discharged from the discharge nozzle.

16. A device manufacturing method comprising:
exposing a substrate coated with a photoresist using an apparatus that projects a pattern of an original, onto the substrate held by a substrate stage having a top plate, to expose the photoresist on the substrate; and
developing the photoresist,
wherein the apparatus comprises a cleaning unit including
a discharge nozzle configured to discharge a fluid toward the top plate, and
a recovery nozzle configured to recover the fluid discharged from the discharge nozzle, and
wherein an opening of the recovery nozzle has a shape which surrounds a path of the fluid discharged from the discharge nozzle.
